(19) United States
(12) Patent Application Publication
(10) Pub. No.: US 2021/0264220 A1
(43) Pub. Date: Aug. 26, 2021

(54) METHOD AND SYSTEM FOR UPDATING EMBEDDING TABLES FOR MACHINE LEARNING MODELS

(71) Applicant: ALIBABA GROUP HOLDING LIMITED, George Town (KY)

(72) Inventors: Wei WEI, San Mateo, CA (US); Wei ZHANG, San Mateo, CA (US); Lingjie XU, San Mateo, CA (US); Lingling JIN, San Mateo, CA (US)

(21) Appl. No.: 16/798,194

(22) Filed: Feb. 21, 2020

(51) Int. Cl. G06K 9/62; G06N 5/04; G06N 20/10; G06F 9/30; G06N 3/08

(52) U.S. Cl. CPC G06K 9/6269; G06N 5/04; G06N 3/08; G06F 9/30036; G06N 20/10

(57) ABSTRACT

The present disclosure relates to a method for updating a machine learning model. The method includes selecting a first column to be removed from a first embedding table to obtain a first reduced number of columns for the first embedding table; obtaining a first accuracy result determined by applying a plurality of vectors into the machine learning model, the plurality of vectors including a first vector having a number of numeric values that are converted using the first embedding table with the first reduced number of columns; and determining whether to remove the first column from the first embedding table in in accordance with an evaluation of the first accuracy result against a first predetermined criterion.

### BACKGROUND

Machine learning has been widely used in various areas, such as recommendation engines, natural language processing, speech recognition, autonomous driving, or search engines. Embedding (e.g., via embedding tables) is used extensively in various machine learning models for mapping from discrete objects, such as words, to dense vectors with numerical numbers as input of the machine learning models for processing. A machine learning model may include a plurality of embedding tables, and each embedding table can be a two-dimensional (2D) table (e.g., a matrix) with rows corresponding to respective words and columns corresponding to embedding dimensions. Sometimes, an embedding table may include thousands to billions of rows (e.g., corresponding to thousands to billions of words) and tens to thousands of columns (e.g., corresponding to tens to thousands of embedding dimensions), resulting in a size of the embedding table ranging from hundreds of MBs to hundreds of GBs. Conventional systems have difficulty with efficiently processing such large embedding tables.

### SUMMARY OF THE DISCLOSURE

Embodiments of the present disclosure provide a method for updating a machine learning model. The method includes selecting a first column to be removed from a first embedding table to obtain a first reduced number of columns for the first embedding table; obtaining a first accuracy result determined by applying a plurality of vectors into the machine learning model, the plurality of vectors including a first vector having a number of numeric values that are converted using the first embedding table with the first reduced number of columns; and determining whether to remove the first column from the first embedding table in accordance with an evaluation of the first accuracy result against a first predetermined criterion.

Embodiments of the present disclosure also provide an apparatus for updating a machine learning model. The apparatus comprising one or more processors; and memory coupled to the one or more processors and storing instructions that, when executed by the one or more processors, cause the apparatus to: select a first column to be removed from a first embedding table to obtain a first reduced number of columns for the first embedding table; obtain a first accuracy result determined by applying a plurality of vectors into the machine learning model, the plurality of vectors including a first vector having a number of numeric values that are converted using the first embedding table with the first reduced number of columns; and determining whether to remove the first column from the first embedding table in accordance with an evaluation of the first accuracy result against a first predetermined criterion.

Embodiments of the present disclosure also provide a non-transitory computer readable storage medium storing a set of instructions that are executable by at least one processor of a computing device to cause the computing device to perform a method for updating a machine learning model. The method includes selecting a first column to be removed from a first embedding table to obtain a first reduced number of columns for the first embedding table; obtaining a first accuracy result determined by applying a plurality of vectors into the machine learning model, the plurality of vectors including a first vector having a number of numeric values that are converted using the first embedding table with the first reduced number of columns; and determining whether to remove the first column from the first embedding table in accordance with an evaluation of the first accuracy result against a first predetermined criterion.

Additional features and advantages of the disclosed embodiments will be set forth in part in the following description, and in part will be apparent from the description, or may be learned by practice of the embodiments. The features and advantages of the disclosed embodiments may be realized and attained by the elements and combinations set forth in the claims.

It is to be understood that both the foregoing general description and the following detailed description are example and explanatory only and are not restrictive of the disclosed embodiments, as claimed.

### BRIEF DESCRIPTION OF THE DRAWINGS

FIG. 1 illustrates an example diagram demonstrating a neural network implemented in a machine learning model including an embedding layer, according to some embodiments of the present disclosure.

FIG. 2A illustrates an example neural network accelerator architecture, consistent with embodiments of the present disclosure.

FIG. 2B illustrates an example neural network accelerator core architecture, consistent with embodiments of the present disclosure.

FIG. 2C illustrates a schematic diagram of an example cloud system incorporating a neural network accelerator, consistent with embodiments of the present disclosure.

FIG. 3 illustrates a schematic diagram of an example apparatus for performing optimization of one or more embedding tables for a machine learning model, according to some embodiments of the present disclosure.

FIG. 4A illustrates an example of using one or more embedding tables for a machine learning model, consistent with embodiments of the present disclosure.

FIG. 4B illustrates an example of using one or more optimized embedding tables with reduced columns after removing columns for a machine learning model, consistent with embodiments of the present disclosure.

FIG. 5A illustrates an example process for updating one or more embedding tables, consistent with embodiments of the present disclosure.

FIG. 5B illustrates an example process for updating one or more embedding tables, consistent with embodiments of the present disclosure.

FIG. 6 illustrates an example process for updating one or more embedding tables for a machine learning model, consistent with embodiments of the present disclosure.

### DETAILED DESCRIPTION

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the invention. Instead, they are merely examples of apparatuses and methods consistent with aspects related to the invention as recited in the appended claims.

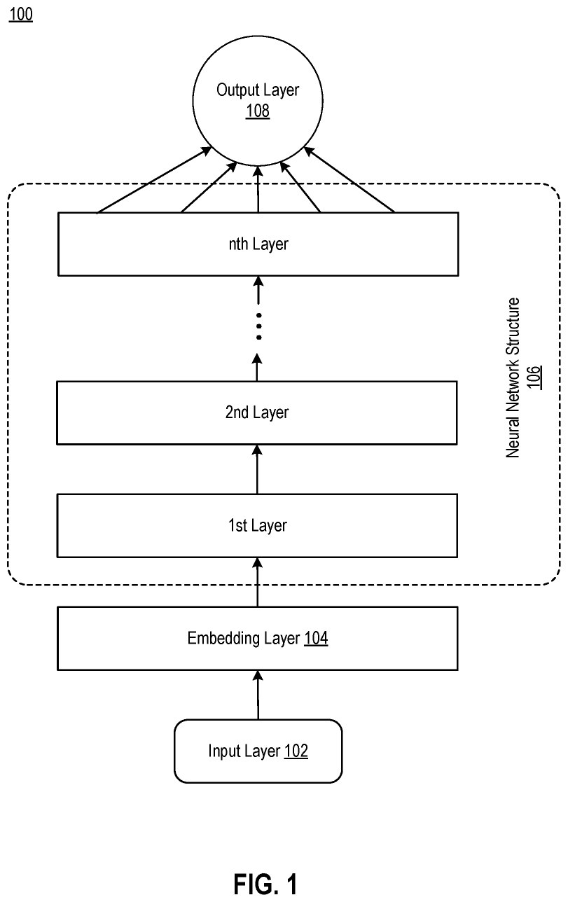

FIG. 1 illustrates an example diagram 100 demonstrating a neural network implemented as a machine learning model, according to some embodiments of the present disclosure. As discussed in the present disclosure, the machine learning model may be used in a recommendation system (e.g., for recommending items such as products, content, or advertisements, etc.) or in any other suitable applications. Some examples of the machine learning model may include a deep learning model such as a wide and deep learning model, DeepFM, deep interest network (DIN), or deep interest evolution network (DIEN). As shown in FIG. 1, an input layer 102 may include a plurality of words (e.g., in texts) in various categories, including but not limited to, user IDs, user profiles, user interests, user behaviors, products, retail stores, places of origin, reviews, advertisements. In some embodiments, the words in input layer 102 may be respectively transformed to binarized sparse vectors (e.g., one-hot encoded vectors) via one-hot coding. A one-hot encoded vector may contain a large number of integers that are zero. As a result, one-hot encoded vectors may be high-dimensional and sparse, and thus inefficient to use in the neural network.

The high-dimensional sparse vectors from input layer 102 may then be processed by an embedding layer 104 to obtain corresponding low-dimensional dense vectors. The sparse vectors may be mapped to respective dense vectors using embedding tables (e.g., embedding matrices). In some embodiments, a respective embedding table may be used for mapping sparse vectors corresponding to words in a certain category to respective dense vectors. Embedding layer 104 may include a plurality of embedding tables for processing a plurality of categories of words in input layer 102. Dense vectors obtained from embedding layer 104 have small dimension and thus are beneficial for the convergence of the machine learning model. The plurality of embedding tables may respectively correspond to mapping different categories of words into corresponding vectors.

As discussed in the present disclosure, a dimension of an embedding table can be reflected by a number of columns in the embedding table. The dimension of the embedding table may correspond to a dimension of a dense vector (e.g., a number of numeric values included therein) obtained using the embedding table. For example, if the embedding table has 100 columns, then the dense vector will have 100 numeric values. In some embodiments, the dimension of the dense vectors of a category corresponds to a multi-dimensional space containing the corresponding words in the category. The multi-dimensional space may be provided for grouping and characterizing semantically similar words. For example, the numeric values of a dense vector may be used to position the corresponding word within the multi-dimensional space and relative to the other words in the same category. Accordingly, the multi-dimensional space may group the semantically similar items (e.g., categories of words) together and keep dissimilar items far apart. Positions (e.g., distance and direction) of dense vectors in a multi-dimensional space may reflect relationships between semantics in the corresponding words.

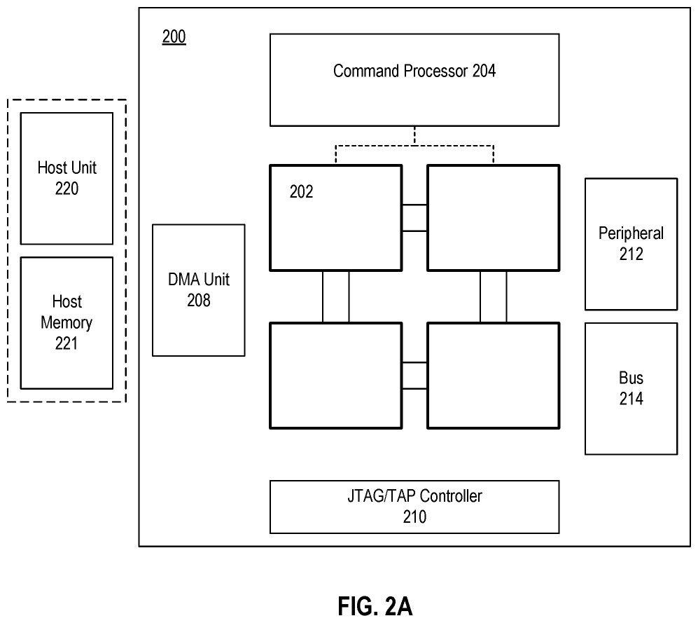

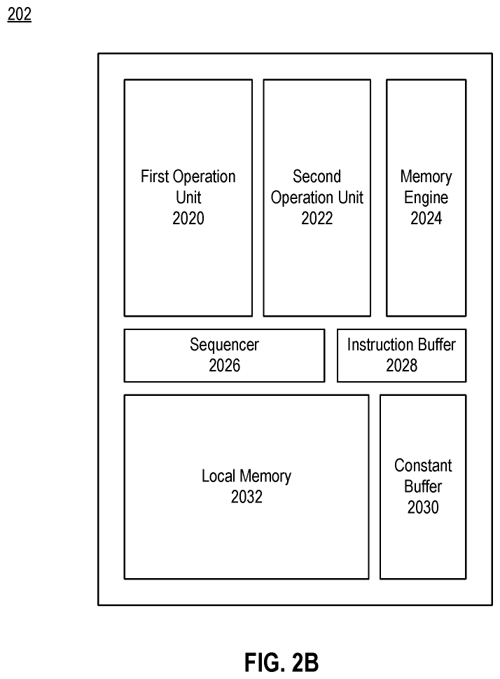

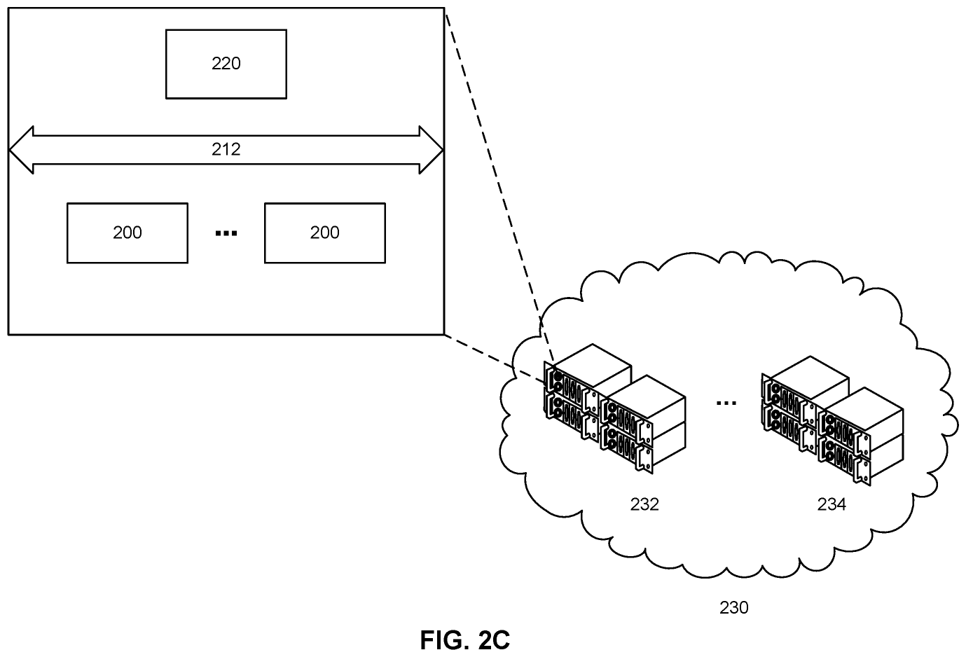

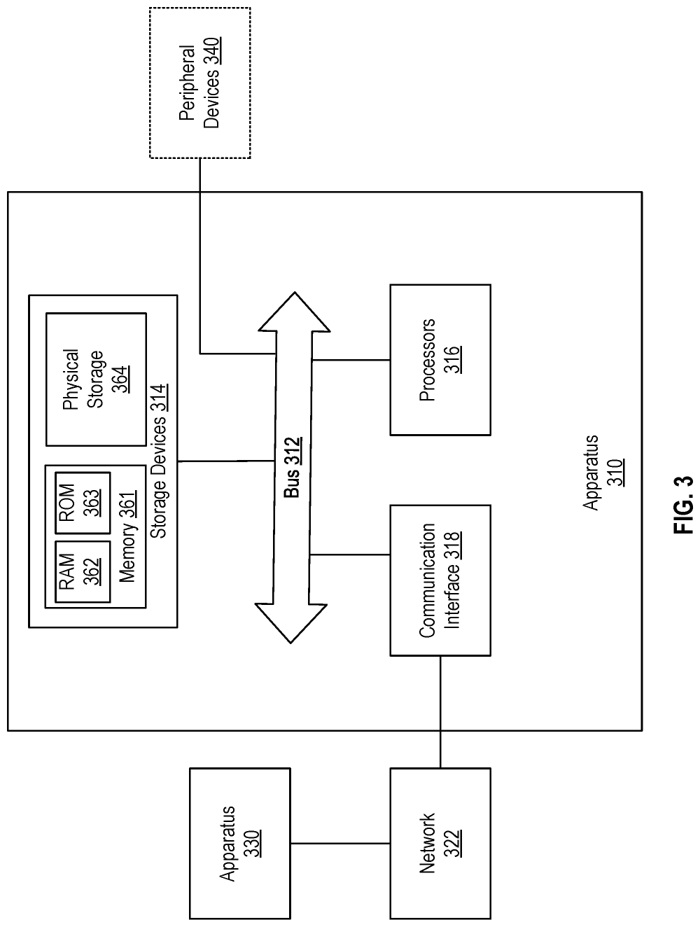

While an embedding space with enough dimensions are desired to represent rich semantic relations through embedding layer 104, the embedding space with too large of dimensions may take up too much memory space, and result in inefficient training and using of the machine learning model. Accordingly, it is desirable to optimize the embedding tables, for example, by removing one or more columns to reduce the dimensions, while maintaining a sufficiently accurate predicting result from using the optimized embedding tables in the machine learning model. In some examples, embedding layer 104 may include embedding tables with dimension on the order of tens to hundreds of columns. It is appreciated that the mapping process performed at embedding layer 104 can be executed by host unit 220 or neural network accelerator 200 as discussed with reference to FIGS. 2A-2C. In some embodiments as discussed in the present disclosure, the optimization of the embedding tables for embedding layer 104 may be performed by a host unit 220 of FIGS. 2A and 2C, an apparatus 300 coupled to host unit 220 as discussed in FIG. 3, or any other suitable components of neural network accelerator 200 as discussed with reference to FIGS. 2A-2C,

After obtaining the dense vectors from different categories of words via embedding player 104, the dense vectors may be concatenated together and fed into a neural network structure 106. In some embodiments, neural network structure 106 may include one or more neural network (NN) layers (e.g., a multi-layer neural network structure 106 as shown in FIG. 1), such as multilayer perceptron (MLP) layers, Neural Collaborative Filtering (NCF) layers, deep neural network (DNN) layers, recurrent neural network (RNN) layers, convolutional neural network (CNN) layers, or any other suitable neural network layers. In some examples, each unit in the RNN layer can either be a long short-term memory (LSTM) or a gated recurrent unit (GRU). It is appreciated that the training or inferencing process performed at neural network layer 106 can be executed by neural network accelerator 200 as discussed with reference to FIGS. 2A-2C.

As shown in FIG. 1, neural network structure 106 is connected to an output layer 108. Output layer 108 may generate an accuracy result (e.g., an accuracy score) used to evaluate whether the optimized embedding tables with reduced columns in embedding layer 104 are sufficient to be used in the machine learning model for the intended purpose (e.g., for recommendation). In some embodiments, a set of embedding tables may be originally obtained prior to or during a training stage. The embedding tables may be further updated (e.g., optimized, or customized for a particular set of words) in the following inferencing stage. The optimized embedding tables may be used to retrain the machine learning model to update the corresponding parameters (e.g., weights and coefficients) in the machine learning model. The embedding tables may then be reoptimized to further reduce the dimensions and sizes while keeping an accuracy score in output layer 108 above a predetermined threshold value. In some embodiments, the optimization of the embedding tables may be performed at any stage, such as before or after training stage, or before or after inferencing stage.

FIG. 2A illustrates an example neural network accelerator architecture, consistent with embodiments of the present disclosure. In the context of this disclosure, a neural network accelerator 200 may also be referred to as a machine learning accelerator or deep learning accelerator. In some embodiments, neural network accelerator 200 may be referred to as a neural network processing unit (NPU) 200. As shown in FIG. 2A, neural network accelerator 200 can include a plurality of cores 202, a command processor 204, a direct memory access (DMA) unit 208, a Joint Test Action Group (JTAG)/Test Access End (TAP) controller 210, a peripheral interface 212, a bus 214, and the like. Neural network accelerator 200 can be used in various neural networks as discussed in the present disclosure.

It is appreciated that cores 202 can perform algorithmic operations based on communicated data. Cores 202 can include one or more processing elements that may include single instruction, multiple data (SIMD) architecture including one or more processing units configured to perform one or more operations (e.g., multiplication, addition, multiply-accumulate, etc.) based on commands received from command processor 204. To perform the operation on the communicated data packets, cores 202 can include one or more processing elements for processing information in the data packets. Each processing element may comprise any number of processing units. According to some embodiments of the present disclosure, neural network accelerator 200 may include a plurality of cores 202, e.g., four cores. In some embodiments, the plurality of cores 202 can be communicatively coupled with each other. For example, the plurality of cores 202 can be connected with a single directional ring bus, which supports efficient pipelining for large neural network models. The architecture of cores 202 will be explained in detail with respect to FIG. 2B.

Command processor 204 can interact with a host unit 220 and pass pertinent commands and data to corresponding core 202. In some embodiments, command processor 204 can interact with host unit 220 under the supervision of kernel mode driver (KMD). In some embodiments, command processor 204 can modify the pertinent commands to each core 202, so that cores 202 can work in parallel as much as possible. The modified commands can be stored in an instruction buffer. In some embodiments, command processor 204 can be configured to coordinate one or more cores 202 for parallel execution.

DMA unit 208 can assist with transferring data between host memory 221 and neural network accelerator 200. For example, DMA unit 208 can assist with loading data or instructions from host memory 221 into local memory of cores 202. DMA unit 208 can also assist with transferring data between multiple accelerators. DMA unit 208 can allow off-chip devices to access both on-chip and off-chip memory without causing a host CPU interrupt. In addition, DMA unit 208 can assist with transferring data between components of neural network accelerator 200. For example, DMA unit 208 can assist with transferring data between multiple cores 202 or within each core. Thus, DMA unit 208 can also generate memory addresses and initiate memory read or write cycles. DMA unit 208 also can contain several hardware registers that can be written and read by the one or more processors, including a memory address register, a byte-count register, one or more control registers, and other types of registers. These registers can specify some combination of the source, the destination, the direction of the transfer (reading from the input/output (I/O) device or writing to the I/O device), the size of the transfer unit, or the number of bytes to transfer in one burst. It is appreciated that neural network accelerator 200 can include a second DMA unit, which can be used to transfer data between other accelerator architectures to allow multiple accelerator architectures to communicate directly without involving the host CPU.

JTAG/TAP controller 210 can specify a dedicated debug port implementing a serial communications interface (e.g., a JTAG interface) for low-overhead access to the accelerator without requiring direct external access to the system address and data buses. JTAG/TAP controller 210 can also have on-chip test access interface (e.g., a TAP interface) that implements a protocol to access a set of test registers that present chip logic levels and device capabilities of various parts.

Peripheral interface 212 (such as a PCIe interface), if present, serves as an (and typically the) inter-chip bus, providing communication between the accelerator and other devices.

Bus 214 (such as a I²C bus) includes both intra-chip bus and inter-chip buses. The intra-chip bus connects all internal components to one another as called for by the system architecture. While not all components are connected to every other component, all components do have some connection to other components they need to communicate with. The inter-chip bus connects the accelerator with other devices, such as the off-chip memory or peripherals. For example, bus 214 can provide high speed communication across cores and can also connect cores 202 with other units, such as the off-chip memory or peripherals. Typically, if there is a peripheral interface 212 (e.g., the inter-chip bus), bus 214 is solely concerned with intra-chip buses, though in some implementations it could still be concerned with specialized inter-bus communications.

Neural network accelerator 200 can also communicate with host unit 220. Host unit 220 can be one or more processing unit (e.g., an X86 central processing unit). As shown in FIG. 2A, host unit 220 may be associated with host memory 221. In some embodiments, host memory 221 may be an integral memory or an external memory associated with host unit 220. In some embodiments, host memory 221 may comprise a host disk, which is an external memory configured to provide additional memory for host unit 220. Host memory 221 can be a double data rate synchronous dynamic random-access memory (e.g., DDR SDRAM) or the like. Host memory 221 can be configured to store a large amount of data with slower access speed, compared to the on-chip memory integrated within accelerator chip, acting as a higher-level cache. The data stored in host memory 221 may be transferred to neural network accelerator 200 to be used for executing neural network models.

In some embodiments, a host system having host unit 220 and host memory 221 can comprise a compiler (not shown). The compiler is a program or computer software that transforms computer codes written in one programming language into instructions for neural network accelerator 200 to create an executable program. In machine learning applications, a compiler can perform a variety of operations, for example, pre-processing, lexical analysis, parsing, semantic analysis, conversion of input programs to an intermediate representation, initialization of a neural network, code optimization, and code generation, or combinations thereof. For example, the compiler can compile a neural network to generate static parameters, e.g., connections among neurons and weights of the neurons.

In some embodiments, host system including the compiler may push one or more commands to neural network accelerator 200. As discussed above, these commands can be further processed by command processor 204 of neural network accelerator 200, temporarily stored in an instruction buffer of neural network accelerator 200, and distributed to corresponding one or more cores (e.g., cores 202 in FIG. 2A) or processing elements. Some of the commands may instruct a DMA unit (e.g., DMA unit 208 of FIG. 2A) to load instructions and data from host memory (e.g., host memory 221 of FIG. 2A) into neural network accelerator 200. The loaded instructions may then be distributed to each core (e.g., core 202 of FIG. 2A) assigned with the corresponding task, and the one or more cores may process these instructions.

It is appreciated that the first few instructions received by the cores 202 may instruct the cores 202 to load/store data from host memory 221 into one or more local memories of the cores (e.g., local memory 2032 of FIG. 2B). Each core 202 may then initiate the instruction pipeline, which involves fetching the instruction (e.g., via a sequencer) from the instruction buffer, decoding the instruction (e.g., via a DMA unit 208 of FIG. 2A), generating local memory addresses (e.g., corresponding to an operand), reading the source data, executing or loading/storing operations, and then writing back results.

According to some embodiments, neural network accelerator 200 can further include a global memory (not shown) having memory blocks (e.g., 4 blocks of 8 GB second generation of high bandwidth memory (HBM2)) to serve as main memory. In some embodiments, the global memory can store instructions and data from host memory 221 via DMA unit 208. The instructions can then be distributed to an instruction buffer of each core assigned with the corresponding task, and the core can process these instructions accordingly.

In some embodiments, neural network accelerator 200 can further include memory controller (not shown) configured to manage reading and writing of data to and from a specific memory block (e.g., HBM2) within global memory. For example, memory controller can manage read/write data coming from core of another accelerator (e.g., from DMA unit 208 or a DMA unit corresponding to the another accelerator) or from core 202 (e.g., from a local memory in core 202). It is appreciated that more than one memory controller can be provided in neural network accelerator 200. For example, there can be one memory controller for each memory block (e.g., HBM2) within global memory.

Memory controller can generate memory addresses and initiate memory read or write cycles. Memory controller can contain several hardware registers that can be written and read by the one or more processors. The registers can include a memory address register, a byte-count register, one or more control registers, and other types of registers. These registers can specify some combination of the source, the destination, the direction of the transfer (reading from the input/output (I/O) device or writing to the I/O device), the size of the transfer unit, the number of bytes to transfer in one burst, or other typical features of memory controllers.

It is appreciated that neural network accelerator 200 of FIG. 2A can be utilized in various neural networks, such as MLPs, DNNs, RNNs, LSTMs, CNNs, or the like. In addition, some embodiments can be configured for various processing architectures, such as NPUs, graphics processing units (GPUs), field programmable gate arrays (FPGAs), tensor processing units (TPUs), application-specific integrated circuits (ASICs), any other types of heterogeneous accelerator processing units (HAPUs), or the like.

FIG. 2B illustrates an example core architecture, consistent with embodiments of the present disclosure. As shown in FIG. 2B, core 202 can include one or more operation units such as first and second operation units 2020 and 2022, a memory engine 2024, a sequencer 2026, an instruction buffer 2028, a constant buffer 2030, a local memory 2032, or the like.

One or more operation units can include first operation unit 2020 and second operation unit 2022. First operation unit 2020 can be configured to perform operations on received data (e.g., matrices). In some embodiments, first operation unit 2020 can include one or more processing units configured to perform one or more operations (e.g., multiplication, addition, multiply-accumulate, element-wise operation, etc.). In some embodiments, first operation unit 2020 is configured to accelerate execution of convolution operations or matrix multiplication operations.

Second operation unit 2022 can be configured to perform a pooling operation, an interpolation operation, a region-of-interest (ROI) operation, and the like. In some embodiments, second operation unit 2022 can include an interpolation unit, a pooling data path, and the like.

Memory engine 2024 can be configured to perform a data copy within a corresponding core 202 or between two cores. DMA unit 208 can assist with copying data within a corresponding core or between two cores. For example, DMA unit 208 can support memory engine 2024 to perform data copy from a local memory (e.g., local memory 2032 of FIG. 2B) into a corresponding operation unit. Memory engine 2024 can also be configured to perform matrix transposition to make the matrix suitable to be used in the operation unit.

Sequencer 2026 can be coupled with instruction buffer 2028 and configured to retrieve commands and distribute the commands to components of core 202. For example, sequencer 2026 can distribute convolution commands or multiplication commands to first operation unit 2020, distribute pooling commands to second operation unit 2022, or distribute data copy commands to memory engine 2024. Sequencer 2026 can also be configured to monitor execution of a neural network task and parallelize sub-tasks of the neural network task to improve efficiency of the execution. In some embodiments, first operation unit 2020, second operation unit 2022, and memory engine 2024 can run in parallel under control of sequencer 2026 according to instructions stored in instruction buffer 2028.

Instruction buffer 2028 can be configured to store instructions belonging to the corresponding core 202. In some embodiments, instruction buffer 2028 is coupled with sequencer 2026 and provides instructions to the sequencer 2026. In some embodiments, instructions stored in instruction buffer 2028 can be transferred or modified by command processor 204.

Constant buffer 2030 can be configured to store constant values. In some embodiments, constant values stored in constant buffer 2030 can be used by operation units such as first operation unit 2020 or second operation unit 2022 for batch normalization, quantization, de-quantization, or the like.

Local memory 2032 can provide storage space with fast read/write speed. To reduce possible interaction with a global memory, storage space of local memory 2032 can be implemented with large capacity. With the massive storage space, most of data access can be performed within core 202 with reduced latency caused by data access. In some embodiments, to minimize data loading latency and energy consumption, SRAM (static random access memory) integrated on chip can be used as local memory 2032. In some embodiments, local memory 2032 can have a capacity of 192 MB or above. According to some embodiments of the present disclosure, local memory 2032 be evenly distributed on chip to relieve dense wiring and heating issues.

FIG. 2C illustrates a schematic diagram of an example cloud system incorporating neural network accelerator 200, consistent with embodiments of the present disclosure. As shown in FIG. 2C, cloud system 230 can provide a cloud service with artificial intelligence (AI) capabilities and can include a plurality of computing servers (e.g., 232 and 234). In some embodiments, a computing server 232 can, for example, incorporate a neural network accelerator 200 of FIG. 2A. Neural network accelerator 200 is shown in FIG. 2C in a simplified manner for simplicity and clarity.

With the assistance of neural network accelerator 200, cloud system 230 can provide the extended AI capabilities of recommendation system, image recognition, facial recognition, translations, 3D modeling, and the like. It is appreciated that, neural network accelerator 200 can be deployed to computing devices in other forms. For example, neural network accelerator 200 can also be integrated in a computing device, such as a smart phone, a tablet, and a wearable device.

FIG. 3 illustrates a schematic diagram of an example apparatus for performing optimization of one or more embedding tables for a machine learning model, according to some embodiments of the present disclosure. An apparatus 310 can include or coupled to a host system including host unit 220 and host memory 221 as discussed with reference to FIGS. 2A-2C. According to FIG. 3, apparatus 310 comprises a bus 312 or other communication mechanism for communicating information, one or more processors 316 communicatively coupled with bus 312 for processing information. Processors 316 can be, for example, one or more microprocessors.

Apparatus 310 can transmit data to or communicate with another apparatus 330 (e.g., including or coupled to the host system) through a network 322. Network 322 can be a local network, an internet service provider, internet, or any combination thereof. Communication interface 318 of apparatus 310 is connected to network 322. In addition, apparatus 310 can be coupled via bus 312 to peripheral devices 340, which comprises displays (e.g., cathode ray tube (CRT), liquid crystal display (LCD), touch screen, etc.) and input devices (e.g., keyboard, mouse, soft keypad, etc.).

Apparatus 310 can be implemented using customized hard-wired logic, one or more ASICs or FPGAs, firmware, or program logic that in combination with apparatus 310 causes apparatus 310 to be a special-purpose machine.

Apparatus 310 further comprises storage devices 314, which may include memory 361 and physical storage 364 (e.g., hard drive, solid-state drive, etc.). Memory 361 may include random access memory (RAM) 362 and read only memory (ROM) 363. Storage devices 314 can be communicatively coupled with processors 316 via bus 312. Storage devices 314 may include a main memory, which can be used for storing temporary variables or other intermediate information during execution of instructions to be executed by processors 316. Such instructions, after being stored in non-transitory storage media accessible to processors 316, render apparatus 310 into a special-purpose machine that is customized to perform operations specified in the instructions (e.g., for optimization of embedding tables as discussed in the present disclosure). The term “non-transitory media” as used herein refers to any non-transitory media storing data or instructions that cause a machine to operate in a specific fashion. Such non-transitory media can comprise non-volatile media or volatile media. Non-transitory media include, for example, optical or magnetic disks, dynamic memory, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, flash memory, register, cache, any other memory chip or cartridge, and networked versions of the same.

Various forms of media can be involved in carrying one or more sequences of one or more instructions to processors 316 for execution. For example, the instructions can initially be carried out on a magnetic disk or solid-state drive of a remote computer. The remote computer can load the instructions into its dynamic memory and send the instructions over a telephone line using a modem. A modem local to apparatus 310 can receive the data on the telephone line and use an infra-red transmitter to convert the data to an infra-red signal. An infra-red detector can receive the data carried in the infra-red signal and appropriate circuitry can place the data on bus 312. Bus 312 carries the data to the main memory within storage devices 314, from which processors 316 retrieves and executes the instructions. In some embodiments, a plurality of apparatuses (e.g., apparatus 310, apparatus 330 of FIG. 3) can be arranged together to form a computing cluster (not shown). Apparatuses can communicate with each other via buses and communication interfaces, processors inside the apparatuses can also communicate with each other via inter-chip interconnects of an interconnect topology.

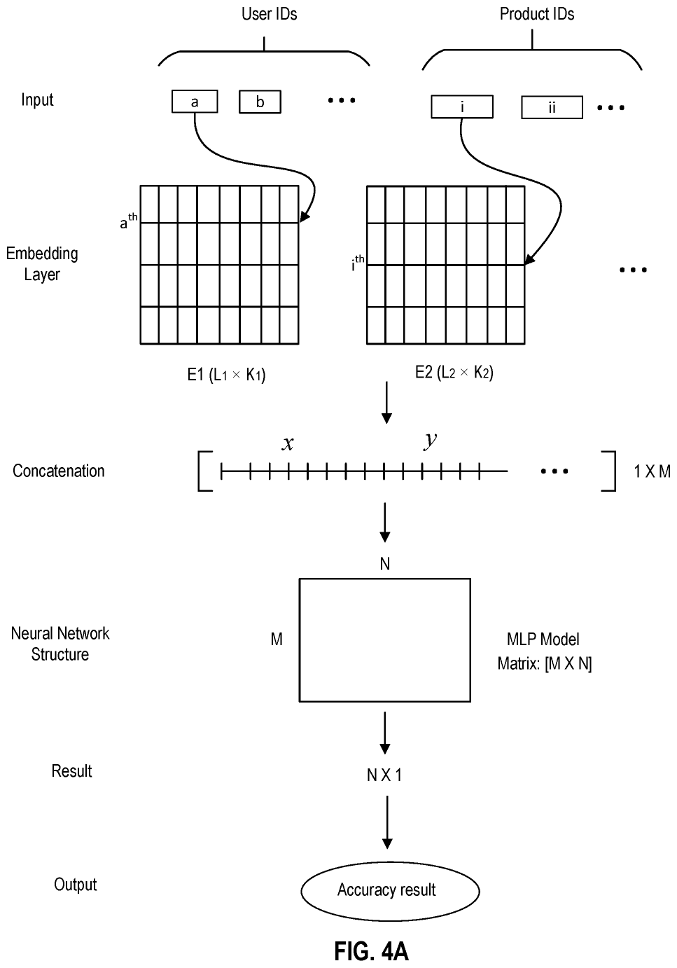

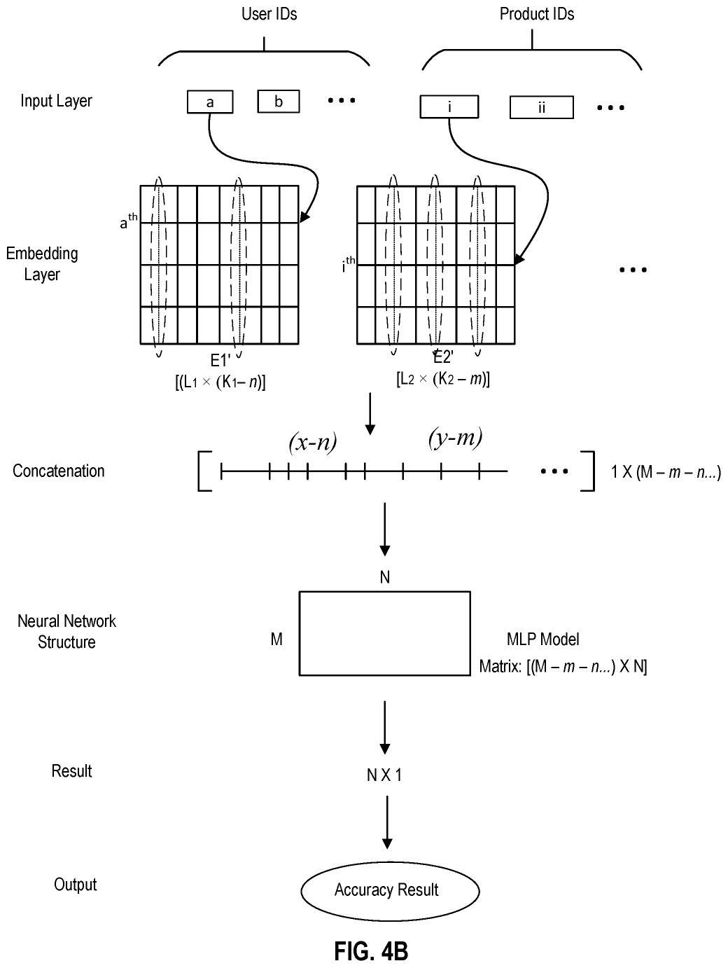

FIG. 4A illustrates an example of using one or more embedding tables including E1 and E2 for a machine learning model, consistent with embodiments of the present disclosure. In some embodiments as discussed in FIG. 1, input of the machine learning model includes a plurality of objects in different categories, such as user IDs, product IDs, etc. The objects in the input may include words or one-hot encoded sparse vectors converted from the words respectively. In some embodiments, the objects may be sorted according to their categories, such that embedding tables associated with respective categories can be used for the corresponding categories in the embedding layer.

As shown in FIG. 4A, objects a and b in a category of user IDs may be organized together, and an embedding table E1 associated with the category of the user IDs is used to map user IDs, such as object a, to a respective dense vector x. Similarly, objects i and ii in a category of product IDs may be organized together, and an embedding table E2 associated with the category of product IDs is used to map product IDs, such as i, to a respective dense vector y. As shown in FIG. 4A, embedding table E1 has L¹ rows and K₁ columns, and embedding table E2 has L₂ rows and K₂ columns. Object a may be mapped based on the a^{th} row of embedding table E1 to obtain dense vector x. Object i may be mapped based on the i^{th} row of embedding table E2 to obtain dense vector y.

After mapping the one or more sparse features to respective dense vectors using the one or more embedding tables, the dense vectors are concatenated together to create a linked vector with a dimension of 1×M, where M corresponds to a total number of columns from the one or more embedding tables (M=K₁+K₂+ . . . ). The concatenated vector is then fed to the neural network model, such as an MLP model executed by neural network accelerator 200 as discussed in FIGS. 2A-2B. The MLP model may include a matrix with a dimension of [M×N]. Applying the concatenated vector (1×M) to the MLP model (M×N) can result in a vector including N elements (N×1). In addition, an output of the machine learning model includes an accuracy result (e.g., an accuracy score) for evaluating the accuracy of the result of the machine learning model, such as reflected by validation of a predicted click-through rate (CRT) for a recommendation system.

FIG. 4B illustrates an example of using one or more optimized embedding tables including E1′ and E2′ with reduced columns after removing one or more columns for a machine learning model, consistent with embodiments of the present disclosure. For example, n columns have been removed from embedding table E1′, and thus embedding table E1′ has L₁ rows and (K₁−n) columns. In addition, m columns have been removed from embedding table E2′, and thus embedding table E2′ has L₁ rows and (K₂−m) columns. The same input as discussed in FIG. 4A are used in FIG. 4B. For example, as shown in FIG. 4B, object a may be mapped based on the a^{th} row of embedding table E1′ to obtain dense vector (x−n), which has lower dimensions than dense vector x in FIG. 4A. Object i may be mapped based on the i^{th} row of embedding table E2′ to obtain dense vector (y-m), which has lower dimensions than dense vector y in FIG. 4B.

After mapping the one or more sparse features to respective dense vectors using the one or more embedding tables with reduced columns in FIG. 4B, the concatenated vector of the dense vectors has a reduced dimension of (1×(M−m−n− . . . )), where M corresponds to a total number of columns after removing one or more columns from the embedding tables (M=(K₁−m)+(K₂−n)+ . . . ). The concatenated vector is then fed to the neural network model, such as an MLP model executed by neural network accelerator 200 as discussed in FIGS. 2A-2B. The MLP model may include a matrix with a reduced dimension of [(M−m−n− . . . )×N]. Applying the concatenated vector [1×(M−m−n− . . . )] to the MLP model [(M−m−n− . . . )×N] can result in a vector including N elements (N×1), similar as the result in FIG. 4A. In addition, an output of the machine learning model includes an accuracy result (e.g., an accuracy score) for evaluating the accuracy of the result of using the one or more embedding tables with reduced dimension in the machine learning model.

If the accuracy score obtained from the machine learning model in FIG. 4B is above a predefined threshold value, then the embedding tables E1′ and E2′ with reduced dimensions and sizes can effectively save memory storage, optimize model sizes, and improve computing efficiency, so as to increase overall machine learning performance.

Various suitable methods can be used to reduce the dimensions, such as numbers of columns, of the embedding tables. For example, a recommendation model having over 100 embedding tables may take over 200 GBs memory space to load all the embedding tables. If one column can be reduced in each embedding table, over 20 GBs of memory space can be saved, and the computing efficiency in the subsequent processes in the neural network layers can be significantly increased.

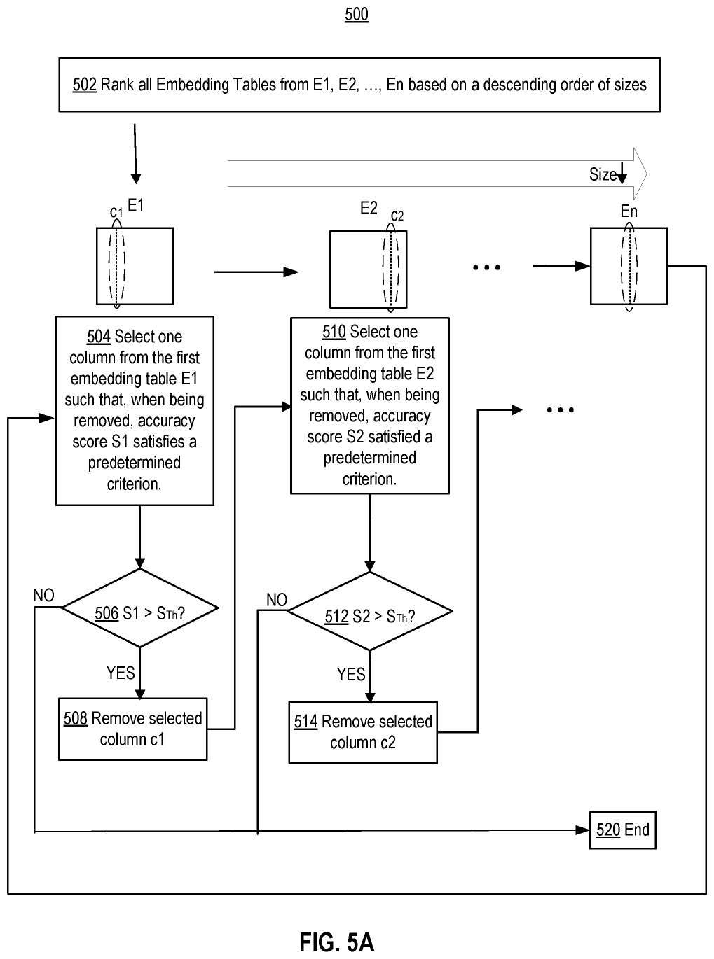

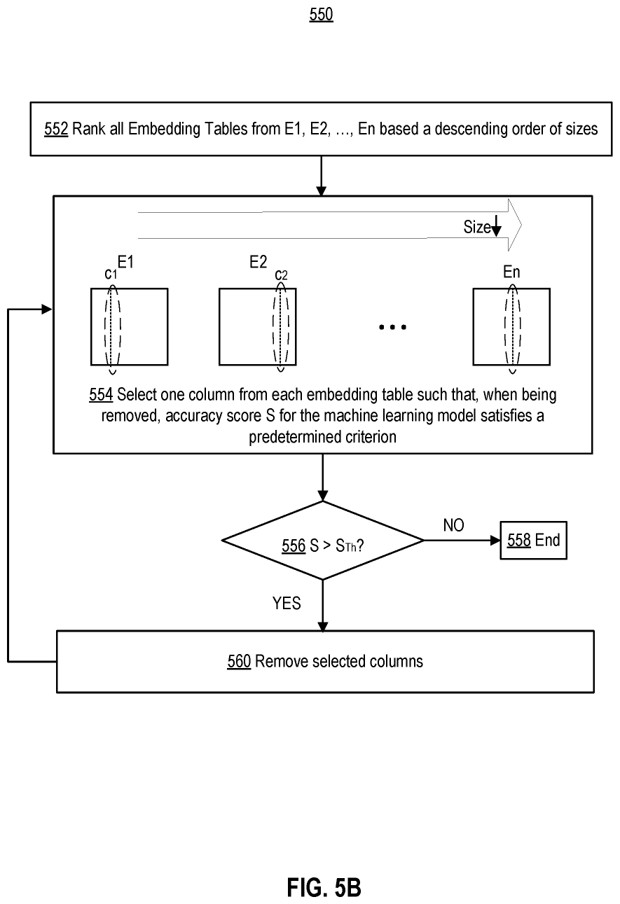

FIG. 5A illustrates an example process 500 for updating (e.g., optimizing, downsizing, customizing, etc.) one or more embedding tables, consistent with embodiments of the present disclosure. At step 502, apparatus 310 in FIG. 3 may include a sorting unit that can rank a plurality of embedding tables according to their respective sizes. For example, N embedding tables may be sorted and ranked according to a descending order of their sizes from E1, E2, . . . , to En.

At step 504, for an embedding table E1 with the largest size, one column c1 is selected from embedding table E1 such that, when being removed, the accuracy result (e.g., accuracy score SD obtained for the machine learning model satisfies a predetermined criterion (e.g., resulting in a relatively high accuracy score S1 compared with removing any of the other columns in embedding table E1, resulting in a highest accuracy score S1, or resulting in the accuracy score S1 above a predetermined threshold value or within a predetermined range). The column may be selected by apparatus 310, which can include or be coupled to host unit 200 as discussed in FIGS. 2A-2C. The accuracy score S1 of the machine learning model may be computed based on one or more embedding tables (e.g., in accordance with the number of embedding tables used in the current process, for example, including the first embedding table E1 without the selected column c1, or the first embedding table and the rest of the embedding tables E2 . . . En). The accuracy score S1 may be determined by the neural network system including the host system and neural network accelerator 200 in FIGS. 2A-2C.

After selecting column c1 in the embedding table E1, apparatus 310 may further compare, at step 506, accuracy score S1 against a predetermined threshold value S_{TH}. When the accuracy score S1 is above the threshold value S_{TH}, apparatus 310 can remove the selected column c1 at step 508, and then move onto the second largest embedding table E2. Alternatively, when the accuracy score S1 is not above the threshold value S_{TH}, apparatus 310 may terminate the updating process 500 at step 520 without removing the selected column c1.

For embedding table E2, steps 510, 512, and 514 are performed by apparatus 310 to select and determine whether to remove column c2 from embedding table E2 in substantially similar manners to steps 504, 506, and 508 as discussed with reference to the first embedding table E1. At step 510, for an embedding table E2 with the second largest size, column c2 is selected from embedding table E2 such that, when being removed, the accuracy result (e.g., accuracy score S2) obtained for the machine learning model satisfies a predetermined criterion (e.g., resulting in a relatively high accuracy score S2 compared with removing any of the other columns in embedding table E2, resulting in a highest accuracy score S2, or resulting in the accuracy score S2 above a predetermined threshold value or within a predetermined range). The column may be selected by apparatus 310, which can include or be coupled to host unit 200 as discussed in FIGS. 2A-2C. The accuracy score S2 of the machine learning model may be computed based on one or more embedding tables (e.g., in accordance with the number of embedding tables used in the current process, for example, including the first embedding table E2 without the selected column c2, or the first embedding table with the reduced columns and the rest of the embedding tables E1, E3, . . . En). The accuracy score S2 may be determined by the neural network system including the host system and neural network accelerator 200 in FIGS. 2A-2C.

After selecting column c2 in the embedding table E2, apparatus 310 may further compare, at step 512, accuracy score S2 against the predetermined threshold value S_{TH}. When the accuracy score S2 is above the threshold value S_{TH}, apparatus 310 can remove the selected column c2 at step 514, and then move onto the third largest embedding table E3 (not shown). Alternatively, when the accuracy score S2 is not above the threshold value S_{TH}, apparatus 310 may terminate the updating process 500 at step 520 without removing the selected column c2.

After the smallest embedding table En is processed similarly to embedding tables E1, E2 and other embedding tables, and while the accuracy score Sn is still above the predetermined threshold value S_{Th}, process 500 may loop back to the largest embedding table E1 to identify another column (e.g., different from column c1) to be removed from embedding table E1.

One or more embedding tables may be processed sequentially in updating process 500, and at the end, one or more columns can be removed from the respective embedding tables to effectively reduce the dimensions of the embedding tables while maintain an accuracy score above the predetermined threshold value.

FIG. 5B illustrates another example process 550 for updating (e.g., optimizing, downsizing, customizing, etc.) one or more embedding tables, consistent with embodiments of the present disclosure. At step 552, apparatus 310 in FIG. 3 may include a sorting unit that can rank a plurality of embedding tables according to their respective sizes. For example, N embedding tables may be sorted and ranked according to a descending order of their sizes from E1, E2, . . . , to En.

Compared to processing the one or more embedding tables one by one in FIG. 5A, at step 554 in FIG. 5B, apparatus 310 can process the one or more embedding tables simultaneously to achieve global updating results. For example, apparatus 310 can select one column from each embedding table at the same time such that, when the respective selected column is being removed from the corresponding embedding table, an accuracy result (e.g., an accuracy score S) obtained for the machine learning model can satisfy a predetermined criterion (e.g., resulting in a relatively high accuracy score S compared with removing any other column from each embedding table, resulting in a highest accuracy score S, or resulting in the accuracy score S above a predetermined threshold value or within a predetermined range).

In some embodiments, apparatus 310 can use a reinforcement learning (RL) model based on machine learning to maximize some notion of cumulative reward. For example, a stochastic policy may be used in a heuristic search method. Reward signal may be defined as an accuracy result (e.g., an accuracy score) of the complete machine model after removing one column from each embedding table. Action may include checking the accuracy score in the resolution group, and then the scenario with the higher accuracy score is rewarded. After the iteration is finished, the winner solution, e.g., removing column c1 from embedding table E1 and removing column c2 from embedding table E2, is obtained with the relatively higher accuracy score.

In some embodiments, apparatus 310 can use a genetic algorithms (GA) to generate high-quality solutions to optimization and search. For example, for each embedding table, which column to remove is a variable and it represents one solution. The accuracy score of the complete model is evaluated for each solution. The population by breeding with probability to mutate may be evolved, and this can be a binary problem for GA. The evolution iteration can be kept until the max iteration is met. After the iteration is finished, the winner solution, e.g., removing column c1 from embedding table E1 and removing column c2 from embedding table E2, is obtained with the relatively higher accuracy score.

Apparatus 310 may obtain the determined accuracy score S and compare, at step 556, accuracy score S against a predetermined threshold value S_{TH}. If the accuracy score is above the threshold value S_{TH}, then the selected one column is removed from each embedding table at step 560. If the accuracy score is not above the threshold value S_{TH}, apparatus 310 may terminate the updating process 550 at step 558 without removing the selected columns. Apparatus can repeat steps 554 and 556 to keep reducing the number of columns until the accuracy score becomes unacceptable (e.g., “NO” at step 556).

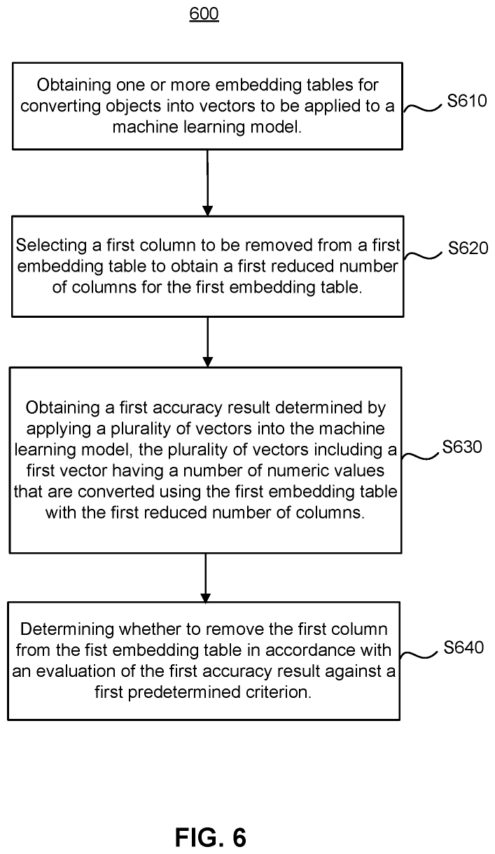

FIG. 6 illustrates an example process 600 for updating (e.g., optimizing, customizing, downsizing, or for any other suitable purpose) one or more embedding tables for a machine learning model, consistent with embodiments of the present disclosure. Process 600 can be implemented by apparatus 300 of FIG. 3, which can include or be coupled to the host system as discussed in FIGS. 2A-2C. Moreover, process 600 can also be implemented by a computer program product, embodied in a computer-readable medium, including computer-executable instructions, such as program code, executed by computers.

As shown in FIG. 6, at step S610, one or more embedding tables can be obtained for converting a plurality of objects into a plurality of vectors to be applied in the machine learning model. As discussed in FIGS. 1 and 4A, the objects from the input may include sparse features, such as discrete words, or one-hot encoded vectors converted from the words respectively. The objects may be sorted according to different categories, such as user IDs, product IDs, etc., such that corresponding embedding tables can be applied as discussed in FIGS. 4A-4B. The one or more embedding tables may be obtained during a training process of the machine learning model.

At step S620, one or more columns (e.g., a first column) may be selected to be removed from a first embedding table to obtain a first reduced number of columns for the first embedding table. As shown in FIGS. 4A-4B, n columns may be selected to be removed from a first embedding table E1 to have a reduced dimension. One or more columns may also be selected to be removed from a second embedding table E2 to obtain a second reduced number of columns (K2−m) in the second embedding table E2. The vectors (x-n) and (y-m) in FIG. 4B may be mapped from objects a and i using embedding tables E1 and E2 with reduced columns and may be applied into the machine learning model for determining the accuracy score.

Different methods may be used to select and remove one or more columns from respective embedding tables. For example, one or more embedding tables may be sequentially processed as discussed in FIG. 5A. As shown in FIG. 5A, a first column c1 may be selected to be removed from the first embedding table E1 such that the first embedding table E1 with the reduced number of columns, in combination with the rest of the plurality of embedding tables E2, . . . En when more than one embedding table are used, can result in that an accuracy result (e.g., an accuracy score S1) for the machine learning model satisfies a predefined criterion (e.g., having a relatively high accuracy score, having an accuracy score above a predetermined threshold value, having an accuracy score within a predefined range, or having a highest accuracy score compared to removing any other column from the first embedding table E1). After selecting the first column c1, if the accuracy score S1 is above the predetermined threshold value S_{TH}, the selected first column c1 is removed from the first embedding table E1. Then a second column c2 is selected to be removed from the second embedding table E2 such that the second embedding table E2 with the reduced number of columns, in combination with the rest of the plurality of embedding tables E1, E3, . . . En when more than one embedding table are used, can result in that an accuracy result (e.g., an accuracy score S2) for the machine learning model satisfies a predefined criterion (e.g., having a relatively high accuracy score, having an accuracy score above a predetermined threshold value, having an accuracy score within a predefined range, or having a highest accuracy score compared to removing any other column from the first embedding table E2). After selecting the second column c2, the accuracy score S2 is further evaluated against the predetermined threshold value S_{TH} to determine whether to remove the column c2 from the second embedding table E2. The one or more embedding tables may be sequentially processed as discussed in FIG. 5A.

In another example, a plurality of embedding tables may be processed in parallel using any suitable model or algorithm to simultaneously remove one column from each embedding table at a time as discussed in FIG. 5B. One or more columns may be selected simultaneously from each of the embedding tables using an optimization model, such as RL or GA, to obtain an accuracy result (e.g., an accuracy score S) for the machine learning model that satisfies a predetermined criterion (e.g., having a relatively high accuracy score, having an accuracy score above a predetermined threshold value, having an accuracy score within a predefined range, or having a highest accuracy score compared to removing any other column from each embedding table). As discussed in the present disclosure, the one or more columns may be selected and determined whether to be removed from one or more embedding tables during an inferencing process following the training process.

At step S630, an accuracy result (e.g., an accuracy score) may be obtained by apparatus 310, and the accuracy score may be determined by applying the plurality of vectors into the machine learning model performed by the neural network system as discussed in FIGS. 2A-2C. As discussed in FIGS. 4A-4B, a number of the numeric values in a dense vector is the same as the number of the columns in the corresponding embedding table. Accordingly, the plurality of vectors have reduced dimensions as they are converted using the one or more embedding tables with the reduced number of columns. The accuracy score may be determined by neural network accelerator 200 and then fed back to apparatus 310 to determine whether to remove the selected columns as discussed in FIGS. 5A-5B.

At step S640, in accordance with a determination that the accuracy result satisfies a predetermined criterion, the selected one or more columns (e.g., column c1 in FIGS. 5A-5B) are removed from the first embedding table E1. In some embodiments, as shown in FIGS. 5A-5B, a selection of another one or more columns to be removed from each of the embedding tables and a determination of another accuracy result against the predetermined criterion are repeatedly performed until the accuracy result no longer satisfies the predetermined criterion. For example, when the accuracy score is not above the predetermined threshold value, the selected one or more columns are preserved in the corresponding embedding table without being removed.

In some embodiments, after removing the one or more columns from the embedding tables, one or more parameters, such as weights or coefficients of the machine learning model may be updated to optimize the machine learning model (e.g., by improving the accuracy score) during a re-training process. Another process of optimizing the embedding tables may be performed after the re-training process to further reduce the dimensions of the embedding tables.

The embodiments may further be described using the following clauses:

1. A method for updating a machine learning model, the method comprising:

selecting a first column to be removed from a first embedding table to obtain a first reduced number of columns for the first embedding table;

obtaining a first accuracy result determined by applying a plurality of vectors into the machine learning model, the plurality of vectors including a first vector having a number of numeric values that are converted using the first embedding table with the first reduced number of columns; and determining whether to remove the first column from the first embedding table in accordance with an evaluation of the first accuracy result against a first predetermined criterion.

2. The method of clause 1, further comprising:

in accordance with a determination that the first accuracy result satisfies the first predetermined criterion, removing the selected first column from the first embedding table.

3. The method of any of clauses 1-2, wherein the first embedding table is obtained during a training process, and the first column is determined whether to be removed from the first embedding table during an inferencing process following the training process.

4. The method of any of clauses 1-3, further comprising:

sorting a plurality of embedding tables including the first embedding table in accordance with a descending order of respective sizes of the plurality of embedding tables, and wherein the first embedding table has a largest size of the plurality of embedding tables.

5. The method of any of clauses 1-4, further comprising:

selecting a second column to be removed from a second embedding table to obtain a second reduced number of columns in the second embedding table, wherein the plurality of vectors applied into the machine learning model for determining a second accuracy result further includes a second vector converted using the second embedding table with the second reduced number of columns;

in accordance with a determination that the second accuracy result satisfies the first predetermined criterion, removing the selected first and second columns from the first and second embedding tables respectively; and repeating a selection of another column to be removed from each of the first and second embedding tables and a determination of another accuracy result until the another accuracy result no longer satisfies the first predetermined criterion.

6. The method of clause 5, further comprising:
selecting the first column to be removed from the first embedding table such that the first embedding table with the first reduced number of columns results in the first accuracy result satisfying a second predetermined criterion; and after removing the first column from the first embedding table:

selecting the second column to be removed from the second embedding table such that the second embedding table with the second reduced number of columns results in the second accuracy result satisfying a third predetermined criterion.

7. The method of clause 5, further comprising:
selecting, simultaneously, the first and second columns to be removed from the first and second embedding tables respectively using an optimization model to obtain the second accuracy result satisfying a fourth predetermined criterion.

8. The method of any of clauses 1-7, comprising:
after removing the first column from the first embedding table, causing to update one or more parameters of the machine learning model to improve the first accuracy result during a re-training process.

9. The method of any of clauses 1-8, wherein the machine learning model includes at least one recommendation model selected from multiplayer perception (MLP), Neural Collaborative Filtering (NCF), Deep Interest Network (DIN), and Deep Interest Evolution Network (DIEN).

10. The method of any of clauses 1-9, wherein the plurality of objects include a plurality of sparse features.

11. The method of clause 1, further comprising:

in accordance with a determination that the accuracy result does not satisfy the first predetermined criterion, foregoing removing the selected first column from the first embedding table.

12. An apparatus for updating a machine learning model, comprising:

one or more processors; and

memory coupled to the one or more processors and storing instructions that, when executed by the one or more processors, cause the apparatus to:
select a first column to be removed from a first embedding table to obtain a first reduced number of columns for the first embedding table;
obtain a first accuracy result determined by applying a plurality of vectors into the machine learning model, the plurality of vectors including a first vector having a number of numeric values that are converted using the first embedding table with the first reduced number of columns; and
determining whether to remove the first column from the first embedding table in accordance with an evaluation of the first accuracy result against a first predetermined criterion.

13. The apparatus of clause 12, in accordance with a determination that the first accuracy result satisfies the first predetermined criterion, the memory further stores instructions for removing the selected first column from the first embedding table.

14. The apparatus of any of clauses 12-13, wherein the first embedding table is obtained during a training process, and the first column is determined whether to be removed from the first embedding table during an inferencing process following the training process.

15. The apparatus of any of clauses 12-14, wherein the memory further stores instructions for:

sorting a plurality of embedding tables including the first embedding table in accordance with a descending order of respective sizes of the plurality of embedding tables, and wherein the first embedding table has a largest size of the plurality of embedding tables.

16. The apparatus of any of clauses 12-15, wherein the memory further stores instructions for:

selecting a second column to be removed from a second embedding table to obtain a second reduced number of columns in the second embedding table, wherein the plurality of vectors applied into the machine learning model for determining a second accuracy result further includes a second vector converted using the second embedding table with the second reduced number of columns;

in accordance with a determination that the second accuracy result satisfies the first predetermined criterion, removing the selected first and second columns from the first and second embedding tables respectively; and repeating a selection of another column to be removed from each of the first and second embedding tables and a determination of another accuracy result until the another accuracy result no longer satisfies the first predetermined criterion.

17. The apparatus of clause 16, wherein the memory further stores instructions for:

selecting the first column to be removed from the first embedding table such that the first embedding table with the first reduced number of columns results in the first accuracy result satisfying a second predetermined criterion; and

after removing the first column from the first embedding table:
selecting the second column to be removed from the second embedding table such that the second embedding table with the second reduced number of columns results in the second accuracy result satisfying a third predetermined criterion.

18. The apparatus of clause 16, wherein the memory further stores instructions for:

selecting, simultaneously, the first and second columns to be removed from the first and second embedding tables respectively using an optimization model to obtain the second accuracy result satisfying a fourth predetermined criterion.

19. The apparatus of any of clauses 12-18, wherein the memory further stores instructions for:

after removing the first column from the first embedding table, causing to update one or more parameters of the machine learning model to improve the first accuracy result during a re-training process.

20. The apparatus of any of clauses 12-19, wherein the machine learning model includes at least one recommendation model selected from multiplayer perception (MLP), Neural Collaborative Filtering (NCF), Deep Interest Network (DIN), and Deep Interest Evolution Network (DIEN).

21. The apparatus of any of clauses 12-20, wherein the plurality of objects include a plurality of sparse features.

22. The apparatus of clause 12, wherein in accordance with a determination that the accuracy score does not satisfy the first predetermined criterion, the memory further stores instructions for preserving the selected one or more columns in the first embedding table.

23. A non-transitory computer readable storage medium storing a set of instructions that are executable by at least one processor of a computing device to cause the computing device to perform a method for updating a machine learning model, the method comprising:

selecting a first column to be removed from a first embedding table to obtain a first reduced number of columns for the first embedding table;

obtaining a first accuracy result determined by applying a plurality of vectors into the machine learning model, the plurality of vectors including a first vector having a number of numeric values that are converted using the first embedding table with the first reduced number of columns; and

determining whether to remove the first column from the first embedding table in accordance with an evaluation of the first accuracy result against a first predetermined criterion.

24. The non-transitory computer readable storage medium of clause 23, wherein the set of instructions that are executable by at least one processor of the computing device cause the computing device to further perform:

in accordance with a determination that the first accuracy result satisfies the first predetermined criterion, removing the selected first column from the first embedding table.

25. The non-transitory computer readable storage medium of any of clauses 23-24, wherein the first embedding table is obtained during a training process, and the first column is determined whether to be removed from the first embedding table during an inferencing process following the training process.

26. The non-transitory computer readable storage medium of any of clauses 23-25, wherein the set of instructions that are executable by at least one processor of the computing device cause the computing device to further perform:

sorting a plurality of embedding tables including the first embedding table in accordance with a descending order of respective sizes of the plurality of embedding tables, and wherein the first embedding table has a largest size of the plurality of embedding tables.

27. The non-transitory computer readable storage medium of any of clauses 23-26, wherein the set of instructions that are executable by at least one processor of the computing device cause the computing device to further perform:

selecting a second column to be removed from a second embedding table to obtain a second reduced number of columns in the second embedding table, wherein the plurality of vectors applied into the machine learning model for determining a second accuracy result further includes a second vector converted using the second embedding table with the second reduced number of columns;

in accordance with a determination that the second accuracy result satisfies the first predetermined criterion, removing the selected first and second columns from the first and second embedding tables respectively; and repeating a selection of another column to be removed from each of the first and second embedding tables and a determination of another accuracy result until the another accuracy result no longer satisfies the first predetermined criterion.

28. The non-transitory computer readable storage medium of clause 27, wherein the set of instructions that are executable by at least one processor of the computing device cause the computing device to further perform:

selecting the first column to be removed from the first embedding table such that the first embedding table with the first reduced number of columns results in the first accuracy result satisfying a second predetermined criterion; and after removing the first column from the first embedding table:
selecting the second column to be removed from the second embedding table such that the second embedding table with the second reduced number of columns results in the second accuracy result satisfying a third predetermined criterion.

29. The non-transitory computer readable storage medium of clause 27, wherein the set of instructions that are executable by at least one processor of the computing device cause the computing device to further perform:

selecting, simultaneously, the first and second columns to be removed from the first and second embedding tables respectively using an optimization model to obtain the second accuracy result satisfying a fourth predetermined criterion.

30. The non-transitory computer readable storage medium of any of clauses 23-29, wherein the set of instructions that are executable by at least one processor of the computing device cause the computing device to further perform:

after removing the first column from the first embedding table, causing to update one or more parameters of the machine learning model to improve the first accuracy result during a re-training process.

31. The non-transitory computer readable storage medium of any of clauses 23-30, wherein the machine learning model includes at least one recommendation model selected from multiplayer perception (MLP), Neural Collaborative Filtering (NCF), Deep Interest Network (DIN), and Deep Interest Evolution Network (DIEN).

32. The non-transitory computer readable storage medium of any of clauses 23-31, wherein the plurality of objects include a plurality of sparse features.

33. The non-transitory computer readable storage medium of clause 23, wherein the set of instructions that are executable by at least one processor of the computing device cause the computing device to further perform:

in accordance with a determination that the accuracy result does not satisfy the first predetermined criterion, foregoing removing the selected first column from the first embedding table.

Embodiments herein include database systems, methods, and tangible non-transitory computer-readable media. The methods may be executed, for example, by at least one processor that receives instructions from a tangible non-transitory computer-readable storage medium. Similarly, systems consistent with the present disclosure may include at least one processor and memory, and the memory may be a tangible non-transitory computer-readable storage medium. As used herein, a tangible non-transitory computer-readable storage medium refers to any type of physical memory on which information or data readable by at least one processor may be stored. Examples include random access memory (RAM), read-only memory (ROM), volatile memory, non-volatile memory, hard drives, CD ROMs, DVDs, flash drives, disks, registers, caches, and any other known physical storage medium. Singular terms, such as “memory” and “computer-readable storage medium,” may additionally refer to multiple structures, such a plurality of memories or computer-readable storage media. Further, plural terms, e.g., embedding tables, do not limit the scope of the present disclosure to function with plural forms only. Rather, it is appreciated that the present disclosure intends to cover machine learning models and the associated systems and methods that can properly work with one or more embedding tables. As referred to herein, a “memory” may comprise any type of computer-readable storage medium unless otherwise specified. A computer-readable storage medium may store instructions for execution by at least one processor, including instructions for causing the processor to perform steps or stages consistent with embodiments herein. Additionally, one or more computer-readable storage media may be utilized in implementing a computer-implemented method. The term “non-transitory computer-readable storage medium” should be understood to include tangible items and exclude carrier waves and transient signals.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the embodiments disclosed herein can be used in various application environments, such as artificial intelligence (AI) training and inference, database and big data analytic acceleration, video compression and decompression, and the like. AI-related applications can involve neural network-based machine learning (ML) or deep learning (DL). Therefore, the embodiments of the present disclosure can be used in various neural network architectures, such as deep neural networks (DNNs), convolutional neural networks (CNNs), recurrent neural networks (RNNs), or the like. For example, some embodiments of present disclosure can be used in AI inference of DNN.

Embodiments of the present disclosure can be applied to many products. For example, some embodiments of the present disclosure can be applied to Ali-NPU (e.g., Hanguang NPU), Ali-Cloud, Ali PIM-AI (Processor-in Memory for AI), Ali-DPU (Database Acceleration Unit), Ali-AI platform, Ali-Data Center AI Inference Chip, IoT Edge AI Chip, GPU, TPU, or the like.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as example only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A method for updating a machine learning model, the method comprising:
selecting a first column to be removed from a first embedding table to obtain a first reduced number of columns for the first embedding table;
obtaining a first accuracy result determined by applying a plurality of vectors into the machine learning model, the plurality of vectors including a first vector having a number of numeric values that are converted using the first embedding table with the first reduced number of columns; and
determining whether to remove the first column from the first embedding table in accordance with an evaluation of the first accuracy result against a first predetermined criterion.

2. The method of claim 1, further comprising:
in accordance with a determination that the first accuracy result satisfies the first predetermined criterion, removing the selected first column from the first embedding table.

3. The method of claim 1, wherein the first embedding table is obtained during a training process, and the first column is determined whether to be removed from the first embedding table during an inferencing process following the training process.

4. The method of claim 1, further comprising:
sorting a plurality of embedding tables including the first embedding table in accordance with a descending order of respective sizes of the plurality of embedding tables, and wherein the first embedding table has a largest size of the plurality of embedding tables.

5. The method of claim 2, further comprising:
selecting a second column to be removed from a second embedding table to obtain a second reduced number of columns in the second embedding table, wherein the plurality of vectors applied into the machine learning model for determining a second accuracy result further includes a second vector converted using the second embedding table with the second reduced number of columns;
in accordance with a determination that the second accuracy result satisfies the first predetermined criterion, removing the selected first and second columns from the first and second embedding tables respectively; and
repeating a selection of another column to be removed from each of the first and second embedding tables and a determination of another accuracy result until the another accuracy result no longer satisfies the first predetermined criterion.

6. The method of claim 5, further comprising:
selecting the first column to be removed from the first embedding table such that the first embedding table with the first reduced number of columns results in the first accuracy result satisfying a second predetermined criterion; and
after removing the first column from the first embedding table:
selecting the second column to be removed from the second embedding table such that the second embedding table with the second reduced number of columns results in the second accuracy result satisfying a third predetermined criterion.

7. The method of claim 5, further comprising:
selecting, simultaneously, the first and second columns to be removed from the first and second embedding tables respectively using an optimization model to obtain the second accuracy result satisfying a fourth predetermined criterion.

8. The method of claim 2, comprising:
after removing the first column from the first embedding table, causing to update one or more parameters of the machine learning model to improve the first accuracy result during a re-training process.

9. The method of claim 1, further comprising:
in accordance with a determination that the accuracy result does not satisfy the first predetermined criterion, foregoing removing the selected first column from the first embedding table.

10. An apparatus for updating a machine learning model, comprising:
one or more processors; and
memory coupled to the one or more processors and storing instructions that, when executed by the one or more processors, cause the apparatus to:
select a first column to be removed from a first embedding table to obtain a first reduced number of columns for the first embedding table;
obtain a first accuracy result determined by applying a plurality of vectors into the machine learning model, the plurality of vectors including a first vector having a number of numeric values that are converted using the first embedding table with the first reduced number of columns; and
determining whether to remove the first column from the first embedding table in accordance with an evaluation of the first accuracy result against a first predetermined criterion.

11. The apparatus of claim 10, in accordance with a determination that the first accuracy result satisfies the first predetermined criterion, the memory further stores instructions for removing the selected first column from the first embedding table.

12. The apparatus of claim 10, wherein the first embedding table is obtained during a training process, and the first column is determined whether to be removed from the first embedding table during an inferencing process following the training process.

13. The apparatus of claim 10, wherein the memory further stores instructions for:
sorting a plurality of embedding tables including the first embedding table in accordance with a descending order of respective sizes of the plurality of embedding tables, and wherein the first embedding table has a largest size of the plurality of embedding tables.

14. The apparatus of claim 11, wherein the memory further stores instructions for:
selecting a second column to be removed from a second embedding table to obtain a second reduced number of columns in the second embedding table, wherein the plurality of vectors applied into the machine learning model for determining a second accuracy result further includes a second vector converted using the second embedding table with the second reduced number of columns;
in accordance with a determination that the second accuracy result satisfies the first predetermined criterion, removing the selected first and second columns from the first and second embedding tables respectively; and
repeating a selection of another column to be removed from each of the first and second embedding tables and a determination of another accuracy result until the another accuracy result no longer satisfies the first predetermined criterion.

15. The apparatus of claim 14, wherein the memory further stores instructions for:
selecting the first column to be removed from the first embedding table such that the first embedding table with the first reduced number of columns results in the first accuracy result satisfying a second predetermined criterion; and
after removing the first column from the first embedding table:
selecting the second column to be removed from the second embedding table such that the second embedding table with the second reduced number of columns results in the second accuracy result satisfying a third predetermined criterion.

16. The apparatus of claim 14, wherein the memory further stores instructions for:
selecting, simultaneously, the first and second columns to be removed from the first and second embedding tables respectively using an optimization model to obtain the second accuracy result satisfying a fourth predetermined criterion.

17. The apparatus of claim 10, wherein in accordance with a determination that the accuracy score does not satisfy the first predetermined criterion, the memory further stores instructions for preserving the selected one or more columns in the first embedding table.

18. A non-transitory computer readable storage medium storing a set of instructions that are executable by at least one processor of a computing device to cause the computing device to perform a method for updating a machine learning model, the method comprising:
selecting a first column to be removed from a first embedding table to obtain a first reduced number of columns for the first embedding table;
obtaining a first accuracy result determined by applying a plurality of vectors into the machine learning model, the plurality of vectors including a first vector having a number of numeric values that are converted using the first embedding table with the first reduced number of columns; and
determining whether to remove the first column from the first embedding table in accordance with an evaluation of the first accuracy result against a first predetermined criterion.

19. The non-transitory computer readable storage medium of claim 18, wherein the set of instructions that are executable by at least one processor of the computing device cause the computing device to further perform:
in accordance with a determination that the first accuracy result satisfies the first predetermined criterion, removing the selected first column from the first embedding table.

20. The non-transitory computer readable storage medium of claim 18, wherein the first embedding table is obtained during a training process, and the first column is determined whether to be removed from the first embedding table during an inferencing process following the training process.

21. The non-transitory computer readable storage medium of claim 18, wherein the set of instructions that are executable by at least one processor of the computing device cause the computing device to further perform:
sorting a plurality of embedding tables including the first embedding table in accordance with a descending order of respective sizes of the plurality of embedding tables, and wherein the first embedding table has a largest size of the plurality of embedding tables.

22. The non-transitory computer readable storage medium of claim 19, wherein the set of instructions that are executable by at least one processor of the computing device cause the computing device to further perform:
selecting a second column to be removed from a second embedding table to obtain a second reduced number of columns in the second embedding table, wherein the plurality of vectors applied into the machine learning model for determining a second accuracy result further includes a second vector converted using the second embedding table with the second reduced number of columns;
in accordance with a determination that the second accuracy result satisfies the first predetermined criterion, removing the selected first and second columns from the first and second embedding tables respectively; and
repeating a selection of another column to be removed from each of the first and second embedding tables and a determination of another accuracy result until the another accuracy result no longer satisfies the first predetermined criterion.

23. The non-transitory computer readable storage medium of claim 22, wherein the set of instructions that are executable by at least one processor of the computing device cause the computing device to further perform:
selecting the first column to be removed from the first embedding table such that the first embedding table with the first reduced number of columns results in the first accuracy result satisfying a second predetermined criterion; and
after removing the first column from the first embedding table:
selecting the second column to be removed from the second embedding table such that the second embedding table with the second reduced number of columns results in the second accuracy result satisfying a third predetermined criterion.

24. The non-transitory computer readable storage medium of claim 22, wherein the set of instructions that are executable by at least one processor of the computing device cause the computing device to further perform:
selecting, simultaneously, the first and second columns to be removed from the first and second embedding tables respectively using an optimization model to obtain the second accuracy result satisfying a fourth predetermined criterion.

25. The non-transitory computer readable storage medium of claim 18, wherein the set of instructions that are executable by at least one processor of the computing device cause the computing device to further perform:
in accordance with a determination that the accuracy result does not satisfy the first predetermined criterion, foregoing removing the selected first column from the first embedding table.
